(19) United States
(12) Patent Application Publication
(10) Pub. No.: US 2025/0106334 A1
(43) Pub. Date: Mar. 27, 2025

(54) STORAGE MEDIUM, METHOD OF CONTROLLING INFORMATION PROCESSING APPARATUS, AND INFORMATION PROCESSING APPARATUS

(71) Applicant: CANON KABUSHIKI KAISHA, Tokyo (JP)

(72) Inventor: AKIHIKO TOKUDA, Kanagawa (JP)

(21) Appl. No.: 18/886,321

(22) Filed: Sep. 16, 2024

(30) Foreign Application Priority Data
Sep. 21, 2023 (JP) 2023-155479

(51) Int. Cl. H04N 1/00

(52) U.S. Cl. CPC H04N 1/00639; H04N 1/00466

(57) ABSTRACT

A method of controlling an information processing apparatus includes acquiring information on a function of setting a folding position of a sheet to be folded in three-part folding processing performed by a sheet processing apparatus included in the printing apparatus, and performing display control to display, on a display unit, a screen in which the folding position is settable based on the acquired information.

### BACKGROUND

### Field of the Disclosure

The present disclosure relates to a storage medium, a method of controlling an information processing apparatus, and the information processing apparatus.

### Description of the Related Art

A printer driver installed in an information processing apparatus that creates print data and transmits the print data to a printing apparatus connected via a network converts data of various kinds of applications operating in the information processing apparatus into the print data.

An output optional apparatus that can fold a printed sheet in three has been used in the market. In recent years, an output optional apparatus that accepts designation of two folding positions for folding a sheet in three has become available.

For example, Japanese Patent Application Laid-Open No. 2018-018189 discusses a technique for visually displaying positions of folding lines, folding directions (mountain fold or valley fold), and an actually folded shape.

There is a printing apparatus on which an existing three-part folding optional apparatus (not accepting designation of folding positions) is mountable in addition to the optional apparatus that can perform three-part folding processing and accept designation of the folding positions. There is an issue that it is not possible to know which optional apparatus is connected to the printing apparatus from the printer driver. Thus, designation of folding positions can be performed even though the existing three-part folding optional apparatus (optional apparatus not accepting designation of folding positions) is connected, and an output result may be different from the setting of the printer driver.

### SUMMARY

According to embodiments of the present disclosure, a non-transitory computer-readable storage medium stores a program for causing a computer to perform a method of controlling an information processing apparatus communicable with a printing apparatus through a network, and the method includes acquiring information on a function of setting a folding position of a sheet to be folded in three-part folding processing performed by a sheet processing apparatus included in the printing apparatus, and performing display control to display, on a display unit, a screen in which the folding position is settable based on the acquired information.

Further features of the present disclosure will become apparent from the following description of exemplary embodiments with reference to the attached drawings.

### BRIEF DESCRIPTION OF THE DRAWINGS

FIG. 1 is an entire configuration diagram of a printing system.

FIG. 2 is a block diagram of an information processing apparatus.

FIG. 3 is a configuration diagram of modules of a printer driver.

FIG. 4 illustrates an example of storing a printer specification description file in an operating system (OS).

FIG. 5 is a block diagram of a software configuration of the information processing apparatus.

FIG. 6 illustrates a processing flow of printer property display according to a first exemplary embodiment.

FIG. 7 illustrates a processing flow of printer setting change according to the first exemplary embodiment.

FIG. 8A illustrates a printer driver setting display screen according to the first exemplary embodiment.

FIG. 8B illustrates a printer driver setting display screen according to the first exemplary embodiment.

FIG. 8C illustrates a printer driver setting display screen according to the first exemplary embodiment.

FIG. 8D illustrates a printer driver setting display screen according to the first exemplary embodiment.

FIG. 8E illustrates a printer driver setting display screen according to the first exemplary embodiment.

FIG. 9A illustrates a sub-processing flow of fold detail setting according to the first exemplary embodiment.

FIG. 9B illustrates a sub-processing flow of fold width detail setting according to the first exemplary embodiment.

FIG. 10A illustrates a printer driver setting display screen according to the first exemplary embodiment.

FIG. 10B illustrates a printer driver setting display screen according to the first exemplary embodiment.

FIG. 11A illustrates a printer driver setting display screen according to a second exemplary embodiment.

FIG. 11B illustrates a printer driver setting display screen according to the second exemplary embodiment.

FIG. 12 illustrates a sub-processing flow of fold width setting according to the second exemplary embodiment.

FIG. 13 illustrates a printer driver display screen according to a third exemplary embodiment.

FIG. 14 illustrates a sub-processing flow of fold width setting according to the third exemplary embodiment.

### DESCRIPTION OF THE EMBODIMENTS

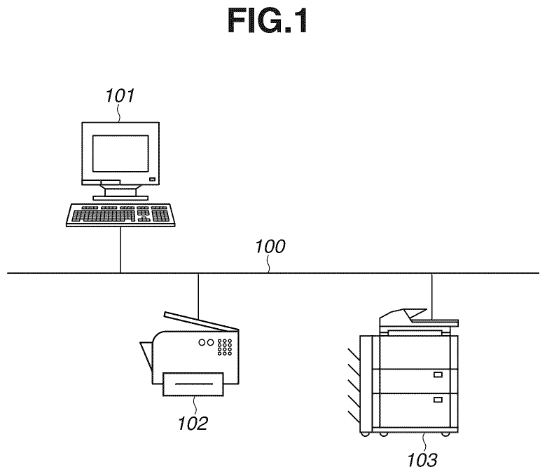

A first exemplary embodiment of the present disclosure is described below with reference to FIG. 1 to FIG. 10B.

Components described in exemplary embodiments are merely examples, and are not intended to limit the scope of the present disclosure to the components.

### System Configuration

FIG. 1 is an entire configuration diagram of a printing system according to the present exemplary embodiment. An information processing apparatus 101 and printing apparatuses 102 and 103 are connected through a network 100 so as to be communicable with one another.

### Hardware Configuration of Information Processing Apparatus

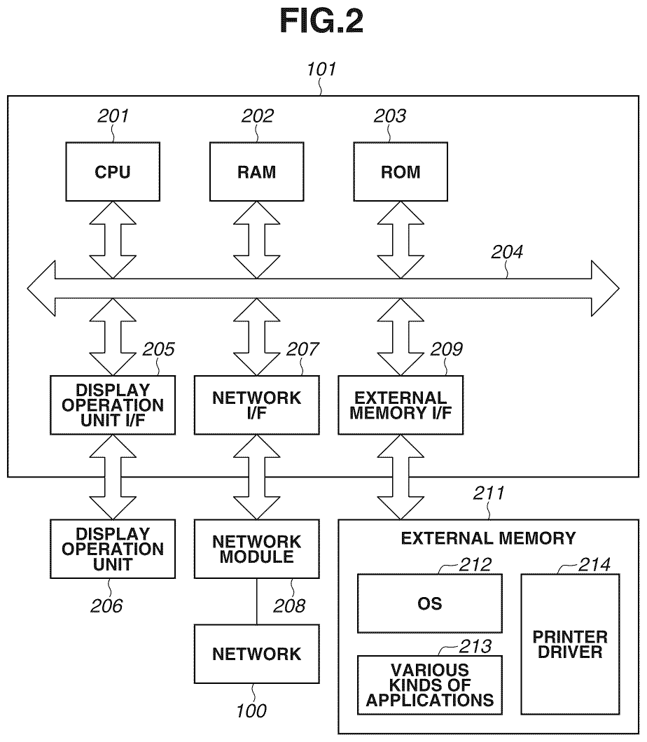

FIG. 2 is a block diagram illustrating a hardware configuration of the information processing apparatus 101.

A central processing unit (CPU) 201 totally controls devices connected to a system bus 204 based on programs loaded into a random access memory (RAM) 202.

The RAM 202 functions as a main memory, a work area, and the like for the CPU 201.

A read only memory (ROM) 203 stores various kinds of basic programs and data for the system.

A display operation unit interface (I/F) 205 performs information display control on a display operation unit 206.

The display operation unit 206 has a display function, and also functions as a touch panel that controls input from a user.

A network I/F 207 controls a network module 208 to implement network communication.

An external memory I/F 209 controls access to an external memory 211, such as a flash memory and a solid state disk.

The external memory 211 stores an operating system program (hereinafter, referred to as “OS”) 212, various kinds of applications 213, and a printer driver 214, and functions as a storage medium in which the information processing apparatus 101 stores data or from which the information processing apparatus 101 reads data.

### Printer Driver

The printer driver 214 is described.

The printer driver 214 is stored in the external memory 211 of the information processing apparatus 101, is read into the RAM 202, and is executed by the CPU 201.

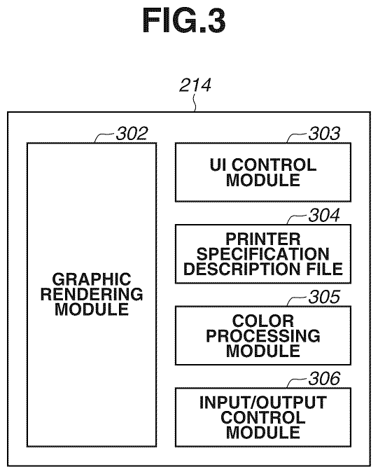

As illustrated in FIG. 3, the printer driver 214 includes a graphic rendering module 302, a user interface (UI) control module 303, a printer specification description file 304, a color processing module 305, and an input/output control module 306. Depending on the function of the printer driver, the printer driver may include another module.

In the present exemplary embodiment, the input/output control module 306 acquires configuration information including functions of the printing apparatuses 102 and 103 (hereinafter, printing apparatuses are representatively denoted as “102”), and changes display contents of the UI control module 303.

The printer driver 214 can be configured to perform processing for a single printer or to perform processing for a plurality of printers depending on the configuration of the modules held in the printer driver 214.

For example, to support the plurality of printers by one printer driver, the graphic rendering module 302 and the UI control module 303 are previously created to be capable of supporting the plurality of printers. Further, in regard to the printer specification description file 304, files for supported printers are included in the printer driver. In such a method, the UI control module 303 displays and controls the UI based on the printer specification description file 304. Further, the graphic rendering module 302 issues a page description language and a printer control command suitable for each of the printers.

### Configuration Information on Printing Apparatus

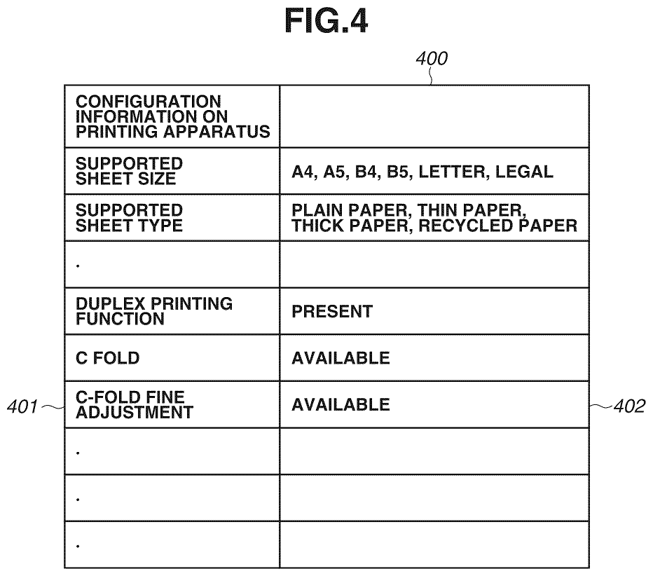

A table 400 illustrated in FIG. 4 illustrates an example of the configuration information acquired from the printing apparatus. In the example, the acquired information includes “sheet size” and “sheet type” supported by the printing apparatus, presence/absence of “duplex printing function” that is one of capabilities of the printing apparatus, availability of “C fold” relating to the present exemplary embodiment, and information 402 on C-fold fine adjustment 401. Details of the C fold are described below.

### System Configuration of Information Processing Apparatus

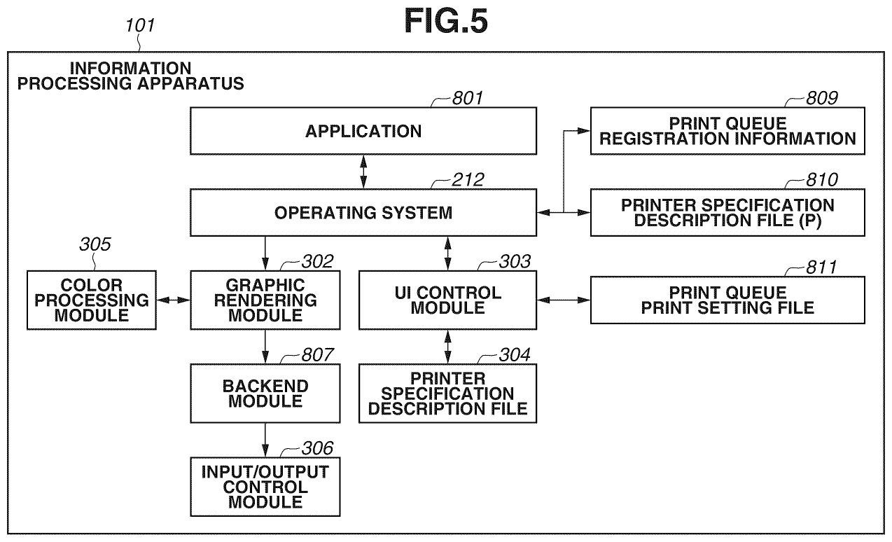

FIG. 5 is a system block diagram of the information processing apparatus 101 in a state where the printer driver 214 is installed.

The graphic rendering module 302, the color processing module 305, the UI control module 303, the printer specification description file 304, and the input/output control module 306 are the same as the modules of the printer driver 214 illustrated in FIG. 3.

A backend module 807 is provided by the OS 212 and is a module for transferring print data generated by the graphic rendering module 302 to the input/output control module 306 that transmits the print data to the printer.

The printer specification description file 304 is for the entire printer driver, and a printer specification description file (P) 810 records current setting values.

### Printer Property Display Processing

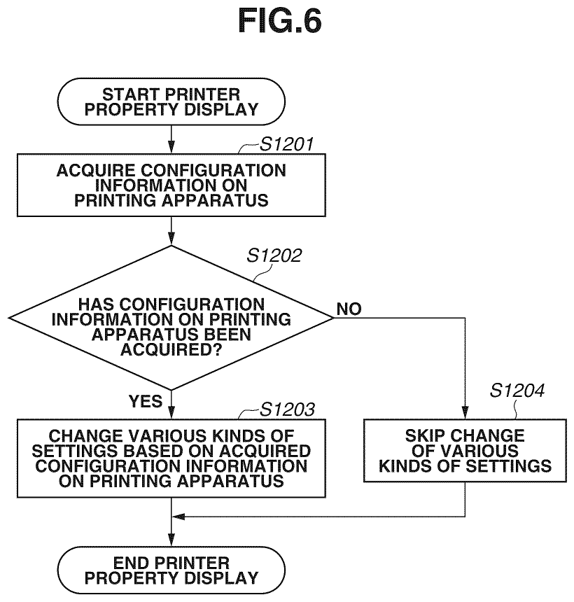

FIG. 6 illustrates a processing flow of printer property display according to the first exemplary embodiment of the present disclosure.

A printer property indicates setting contents of various kinds of printer drivers displayed when the user performs an operation, such as a right click, on a printer queue installed in the OS. For example, in the case of Windows 10®, a printer driver queue is displayed on “Devices and Printers” in “Control Panel”.

Hereinafter, the exemplary embodiment is described by using, as an example, a folding function (hereinafter, referred to as “C fold”) of creating a product in which both folding portions are mountain-folded (or both folding portions are valley-folded) among functions of folding a printed sheet in three, as a function of the printer. Hereinafter, each step of the processing is denoted by “S”.

The processing is implemented when the CPU 201 of the information processing apparatus 101 loads programs into the RAM 202 and executes the programs.

The processing starts when a property screen of the printer driver is displayed from the printer queue of the OS.

In step S1201, the CPU 201 acquires various kinds of configuration information on the printing apparatus 102 at a port registered as a port of the printer driver.

In step S1202, the CPU 201 determines whether the configuration information on the printing apparatus 102 has been normally acquired. In a case where it is determined in step S1202 that the configuration information on the printing apparatus 102 has been normally acquired (YES in step S1202), the processing proceeds to step S1203. In contrast, in a case where it is determined in step S1202 that the configuration information has not been normally acquired (NO in step S1202), the processing proceeds to step S1204.

In step S1203, processing for applying various kinds of settings of the printer driver 214 based on the acquired configuration information and capabilities of the printing apparatus 102 is performed (a specific example is described below).

In the case where the configuration information on the printing apparatus 102 has not been normally acquired in step S1202, various kinds of settings are not changed in step S1204. In the present exemplary embodiment, it is described in step S1201 that the various kinds of configuration information on the printing apparatus are acquired at a timing when the printer property is displayed, but alternatively, a button for acquiring the configuration information may be disposed in the printer property, and the user may be prompted to perform acquisition.

The configuration information may be acquired by any method as long as the method uses a print protocol that enables communication between the printing apparatus 102 and the information processing apparatus 101.

Examples of the information that can be acquired as the configuration information include a configuration of an optional apparatus connected to the printing apparatus 102 and capabilities achievable based on the configuration.

### Details of Settings Application Processing: S1203

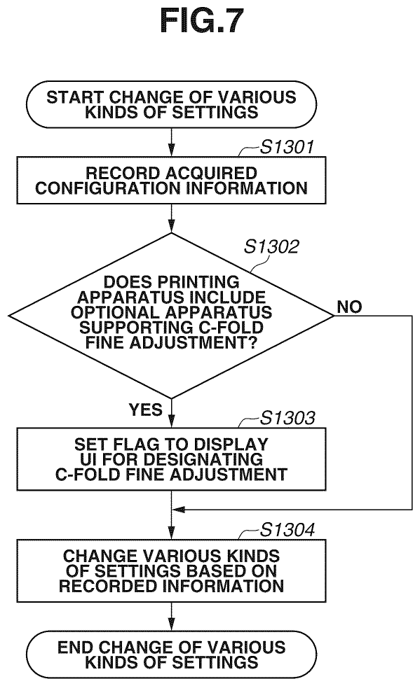

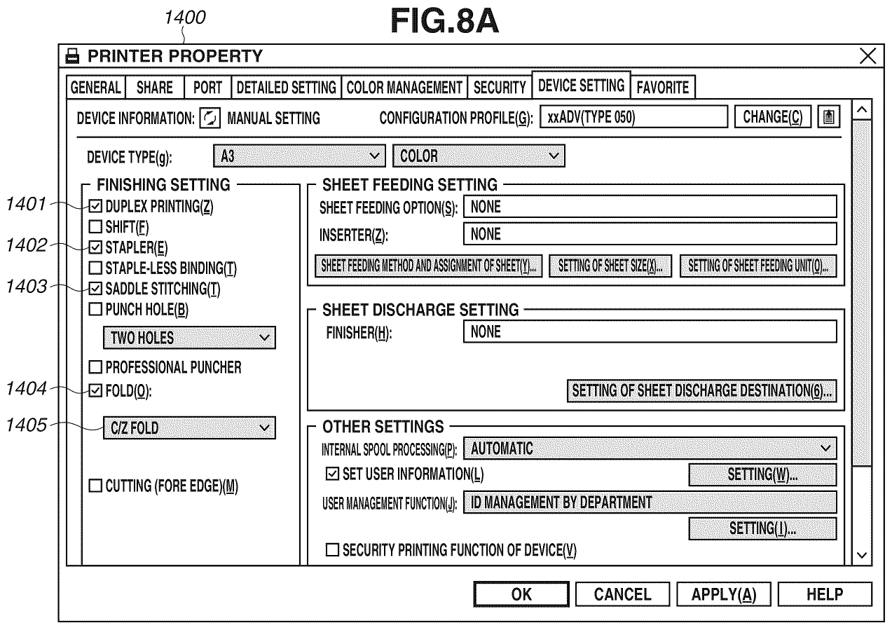

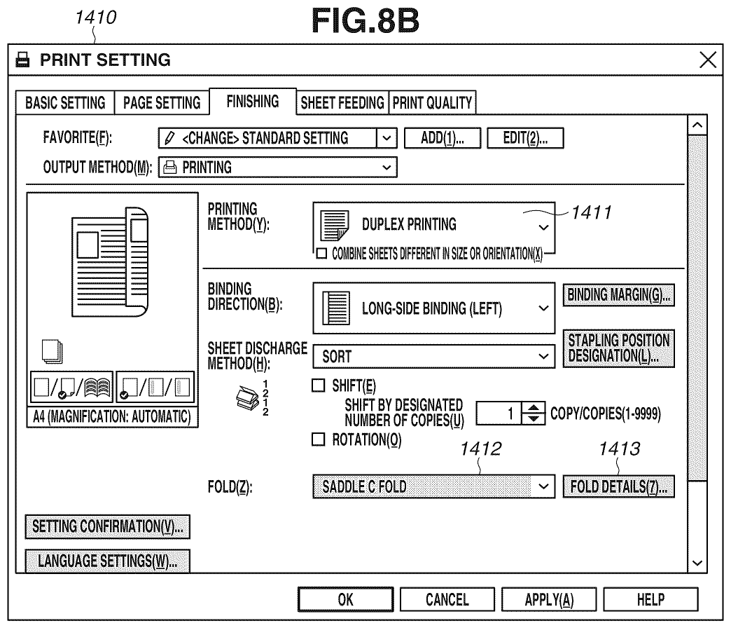

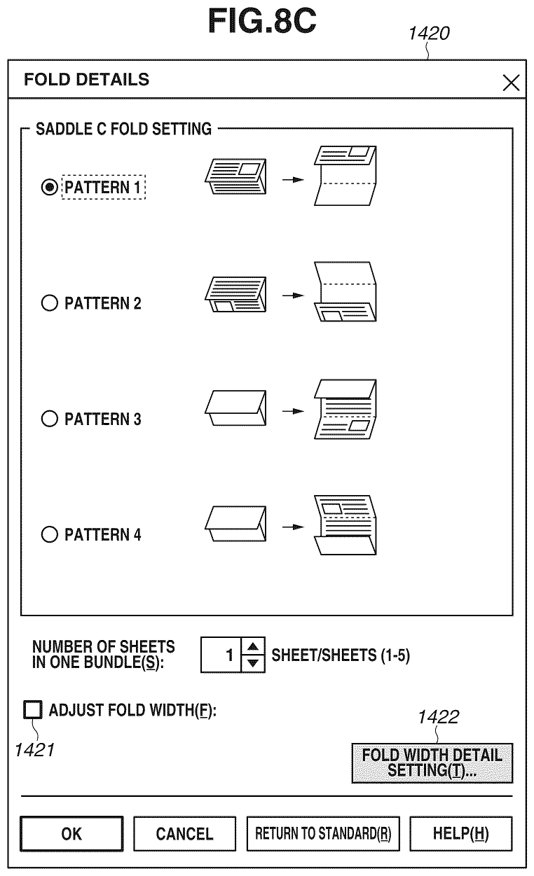

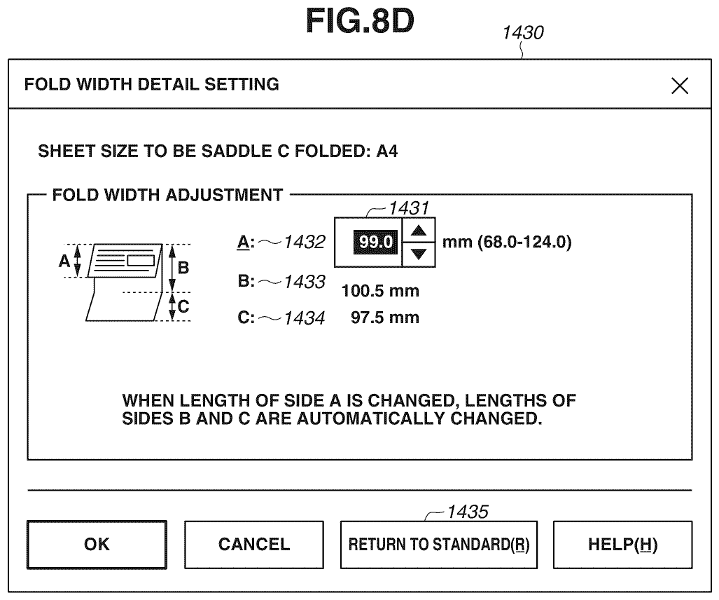

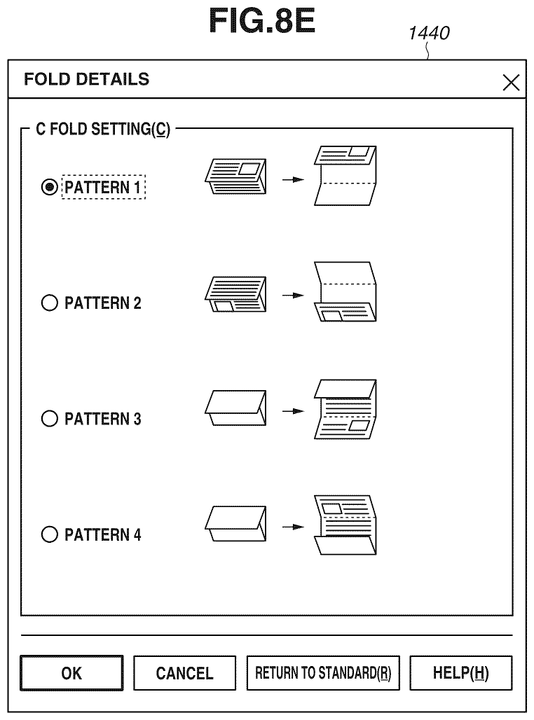

FIG. 7 illustrates a detailed flow of the processing in step S1203 according to the present exemplary embodiment, and FIGS. 8A to 8E each illustrate a display example of the printer driver.

In step S1301, the CPU 201 records the configuration information on the printing apparatus 102 acquired in step S1201, in the RAM 202 or the like.

In step S1302, the CPU 201 determines whether the configuration information on the printing apparatus 102 recorded in step S1301 includes the information 402 indicating that an optional apparatus supporting the C-fold fine adjustment is connected. In a case where it is determined in step S1302 that the configuration information includes the information 402 indicating that the optional apparatus supporting the C-fold fine adjustment is connected (YES in step S1302), the processing proceeds to step S1303. Otherwise (NO in step S1302), the processing proceeds to step S1304.

In step S1303, the CPU 201 sets a flag (not illustrated) to display a UI for designating the C-fold fine adjustment.

In step S1304, current setting values of various kinds of setting items of the printer driver are changed based on the configuration information on the printing apparatus recorded in step S1301. The processing then ends.

The C-fold fine adjustment is a function of designating, for example, each of two portions to be mountain-folded (or valley-folded) of a sheet by designating a distance thereof from an end of the sheet.

FIG. 8A illustrates an example of a printer property 1400 after the configuration information is acquired.

A checkbox 1404 indicates whether the optional apparatus (not illustrated) that can perform processing for folding a sheet has been connected to the printing apparatus 102.

A dropdown list 1405 is to select a specific sheet folding method available on the connected optional apparatus. In FIG. 8A, “C/Z fold” indicates that the optional apparatus can perform both “C fold” and “Z fold” in which mountain fold and valley fold are performed on the sheet, as folding capabilities of the optional apparatus that can perform the processing for folding a sheet.

As an example of the processing at this time, there is a case where the configuration of the printing apparatus in the driver setting immediately before the configuration information is acquired indicates an optional apparatus that does not support the C-fold fine adjustment, but the acquired configuration information includes information indicating the optional apparatus that supports the C-fold fine adjustment. In this case, a C-fold fine adjustment available flag (not illustrated) is set. In a case where the flag has been set, a fold detail screen 1420 illustrated in FIG. 8C is displayed.

A checkbox 1421 in the fold detail screen 1420 is checked to “adjust fold width”.

A “fold width detail setting” button 1422 becomes selectable when the checkbox 1421 is checked, whereas when the checkbox 1421 is not checked, the “fold width detail setting” button 1422 is not selectable and, for example, is grayed out.

On the other hand, when the configuration of the printing apparatus with regard to the driver setting immediately before and immediately after the configuration information is acquired indicates the optional apparatus that does not support the C-fold fine adjustment, the C-fold fine adjustment available flag (not illustrated) has not been set or is not set. In this case, the function relating to the C-fold fine adjustment is not displayed as with a fold detail screen 1440 illustrated in FIG. 8E.

A fold width detail setting screen 1430 illustrated in FIG. 8D is a display example of a fold width detail setting screen displayed when the “fold width detail setting” button 1422 is clicked. In this example, only a length of a side A 1432 (on upper end side of sheet) in the drawing is input, and lengths of a side B 1433 (middle side of C-folded sheet) and a side C 1434 (on lower end side of sheet) are automatically calculated. Details of the automatic calculation are described below.

### C Fold Detail Setting Processing

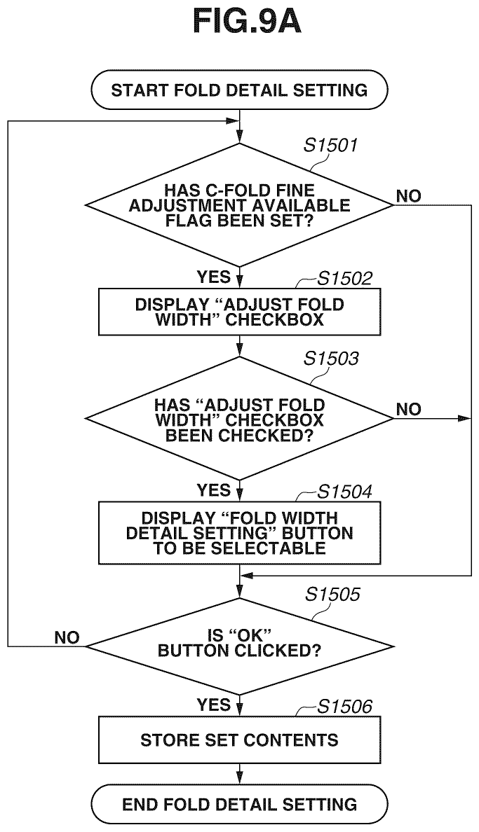

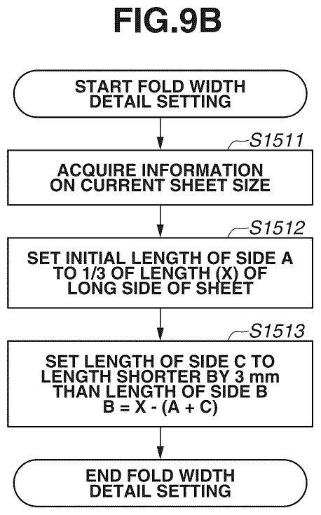

FIG. 9A illustrates a processing flow of the printer driver after a “fold details” button 1413 illustrated in FIG. 8B is clicked.

In step S1501, the CPU 201 determines whether the C-fold fine adjustment available flag has been set. In a case where the flag has not been set (NO in step S1501), the UI control module 303 displays the fold detail screen 1440 not including the checkbox 1421 to “adjust fold width”.

In a case where the flag has been set (YES in step S1501), the processing proceeds to step S1502.

In step S1502, the UI control module 303 displays the fold detail screen 1420, and displays the checkbox 1421 to “adjust fold width”. In addition, the UI control module 303 also displays the “fold width detail setting” button 1422 that is selectable when the checkbox 1421 is checked.

In step S1503, the CPU 201 determines whether the checkbox 1421 to “adjust fold width” has been checked. In a case where the checkbox 1421 has been checked (YES in step S1503), the processing proceeds to step S1504.

In step S1504, the “fold width detail setting” button 1422 is displayed in a selectable manner. When the “fold width detail setting” button 1422 is pressed, the fold width detail setting screen 1430 illustrated in FIG. 8D is displayed, and sub-processing illustrated in FIG. 9B described below is performed.

In step S1505, in a case where an “OK” button is clicked in the screen 1420 or 1440 (YES in step S1505), the processing proceeds to step S1506.

In step S1506, the contents set so far are set (stored), and the processing then ends.

### Sub-Processing of Fold Width Determination

FIG. 9B illustrates a processing flow of an example of the automatic calculation for determining fold widths (lengths of sides A, B, and C).

In step S1511, information on a length of a long side that is a side orthogonal to a folding direction, of the current sheet size is acquired from the printer specification description file 304 or the like.

In step S1512, an initial length of the side A 1432 corresponding to a front surface when the sheet is C-folded is set to ⅓ of the length of the long side of a sheet.

In step S1513, the length of the side C 1434 to be folded inside of the C fold is set to a length shorter by a predetermined length (3 mm in illustrated example) than the length of the side B 1433. As a result, the lengths of the three sides are determined. The user designates a value of the length of the side A 1432 between a maximum value (“124.0” in the example illustrated in FIG. 8D) and a minimum value (“68.0” in the example illustrated in FIG. 8D) inclusive of the side A 1432 based on a conveyance path of the sheet, the folding function, and the like, without changing relationship of the side B 1433 and the side C 1434. When the length of the side A 1432 is designated, the lengths of the side B 1433 and the side C 1434 are changed to the values maintaining the relationship (C=B−3 in the present exemplary embodiment). The sub-processing then ends.

In a case where a value greater than the maximum value or a value less than the minimum value is entered, the value is rounded to the maximum value or the minimum value, or a message indicating that a value out of a range has been entered is displayed to warn the user thereof.

A “return to standard” button 1435 is a button to return the setting values to initial values described in the printer specification description file (P) 810. The function of this button is the same in this screen and in other screens.

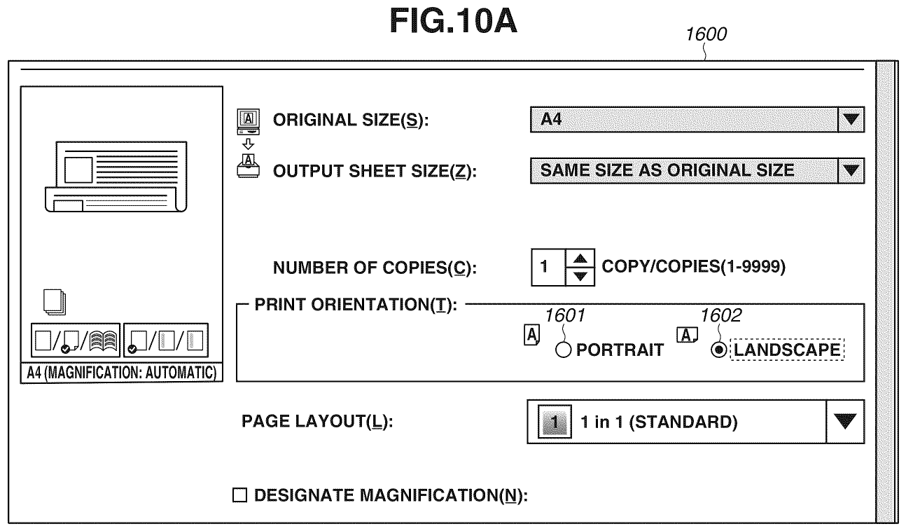

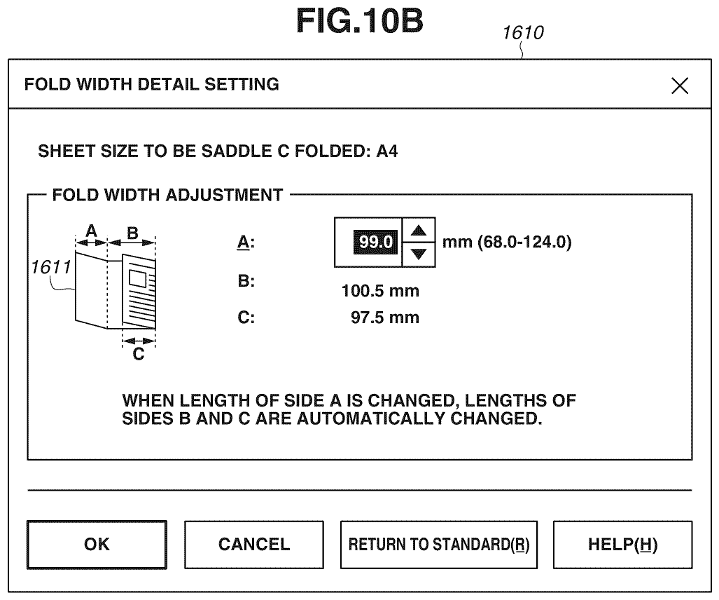

The example in which a “portrait” checkbox 1601 has been checked as a print orientation in a fold width detail setting screen 1600 illustrated in FIG. 10A is described above. In a case where a “landscape” checkbox 1602 has been selected, an icon 1611 displayed on a fold width detail setting screen 1610 illustrated in FIG. 10B shows a folded state in the case where the print orientation of the sheet is landscape. The icon 1611 in the fold width detail setting screen (1430 or 1610) may be changed based on the sheet size, the sheet type, or the lengths of the sides A, B, and C.

According to the above-described exemplary embodiment, it is possible to designate the folding positions in the printer driver only in the case where it is determined that the configuration information includes the information indicating that the optional apparatus supporting the C-fold fine adjustment is connected.

In the first exemplary embodiment, the case where the setting is made for singly folding each sheet is described.

Setting of folding positions in a case of folding a bundle including a plurality of sheets is described below as a second exemplary embodiment.

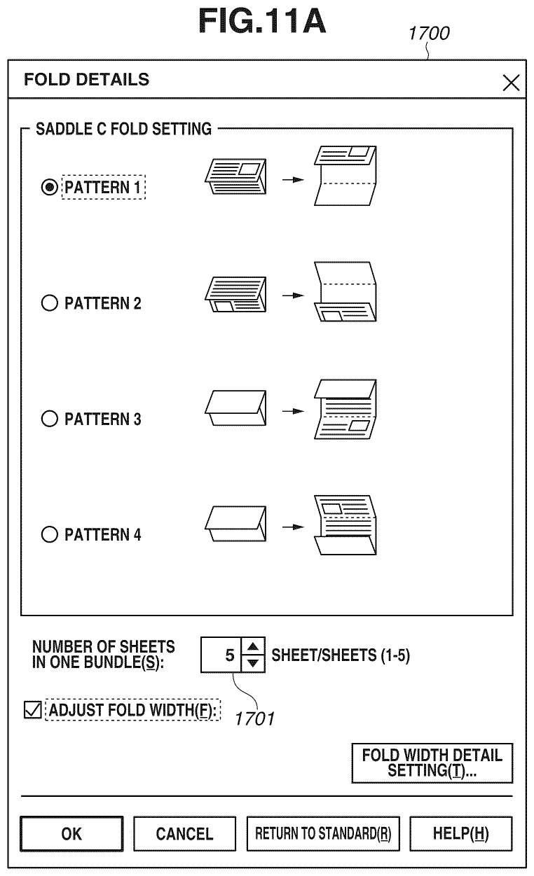

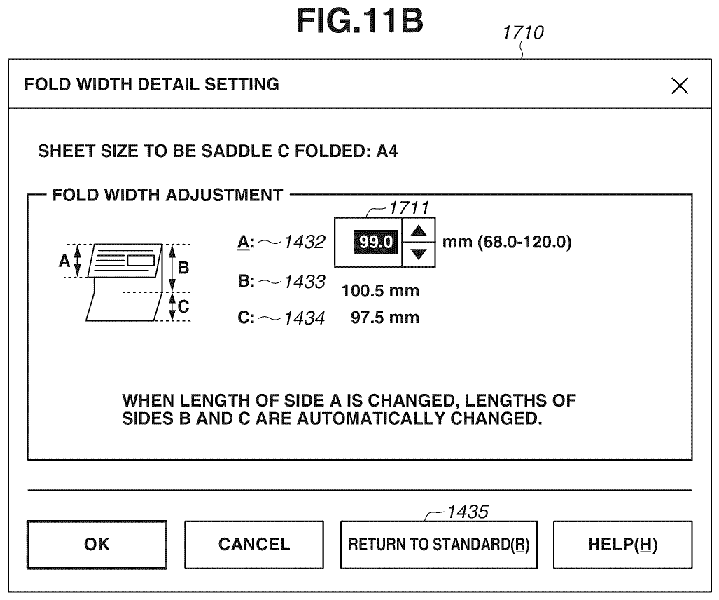

In a fold detail screen 1700 illustrated in FIG. 11A, the number of sheets in one bundle can be designated in a “number of sheets in one bundle” field 1701. To collectively fold the bundle of sheets, it is necessary to adjust the fold width (length of each side).

In an example in a fold width detail setting screen 1710 illustrated in FIG. 11B, the maximum value of the side A 1432 in a field 1711 is set to “120.0” different from “124.0” in the screen 1430 illustrated in FIG. 8D. Alternatively, the lengths of the side B 1433 and the side C 1434 may be adjusted in the automatic calculation.

### Fold Width Setting Processing Based on Number of Sheets of One Bundle

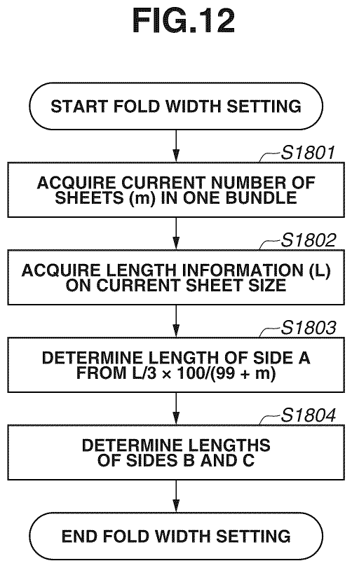

FIG. 12 illustrates a processing flow of determination of the lengths of the sides based on the number of sheets in one bundle.

In step S1801, a value (m) in the “number of sheets in one bundle” field 1701 currently set is acquired.

In step S1802, length information (L) on a side (normally, a long side) orthogonal to a C folding direction is acquired from information on the sheet size currently set.

In step S1803, the length of the side A is determined by a predetermined mathematical formula. In this example, “1” is set as an initial value of the number of sheets in one bundle, and the length of the side A is reduced as the number of sheets in one bundle is increased. For example, the following formula is used:

Length of side A=L/3×100/(99+m).

In step S1804, the lengths of the side B and the side C are determined from the relationship that the length of the side C is shorter by 3 mm than the length of the side B. The sub-processing then ends.

In a third exemplary embodiment, processing for automatically adjusting the folding positions based on the sheet type, such as thick paper, is described.

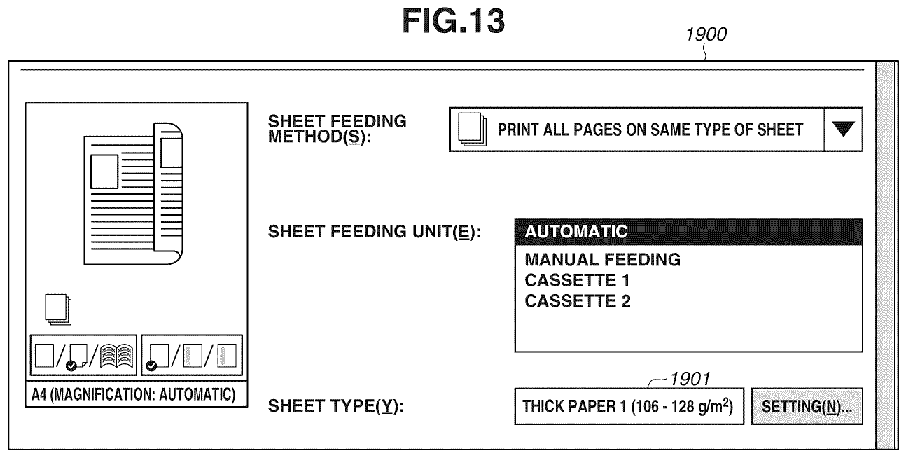

FIG. 13 illustrates a screen 1900 for setting the sheet type in the printer driver. In the screen, a sheet type 1901 is set to “thick paper 1 (106 to 128 [g/m²])”. In a case where a basis weight (range of numerical values in parentheses) of plain paper that is an initial sheet type is 64 to 75 [g/m²], the maximum value of the side A may be adjusted when the thick paper 1 or the like having a basis weight greater than the basis weight of the plain paper is selected.

### Fold Width Setting Processing Based on Basis Weight of Paper

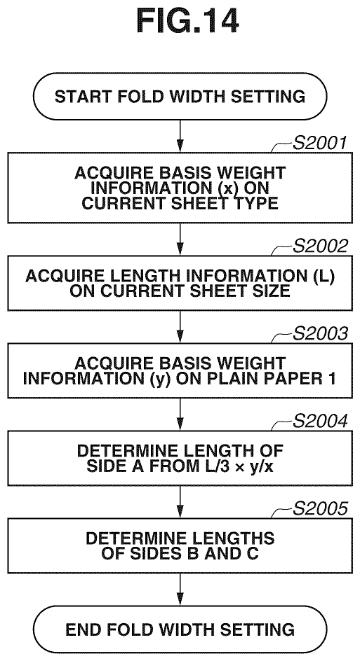

FIG. 14 illustrates a processing flow of determination of the lengths of the sides based on (a basis weight of paper) of the sheet type currently set.

In step S2001, the CPU 201 acquires the sheet type 1901 currently set, and also acquires basis weight information (x) on the sheet type.

In step S2002, the CPU 201 acquires length information (L) on a side (normally, a long side) orthogonal to the C folding direction from information on the sheet size currently set.

In step S2003, basis weight information (y) on the initial sheet type (plain paper 1) is acquired from information on the initial sheet type.

In step S2004, the length of the side A is determined by a predetermined mathematical formula. In this example, a value obtained by dividing the basis weight of the plain paper 1 by the basis weight of the current sheet type acquired in step S2001 is multiplied such that the length of the side A is reduced as the basis weight of the sheet type is increased. For example, the following formula is used:

Length of side A=L/3×y/x.

In step S2005, the lengths of the side B and the side C are determined from the relationship that the length of the side C is shorter by 3 mm than the length of the side B. The sub-processing then ends.

The case where the initial value of the length of the side A is set to ⅓ of the length of the sheet, and the case where the initial value of the number of sheets in one bundle is set to 1 are described; however, information on these initial values may be acquired from the printing apparatus and may be applied to setting values of the driver.

According to the above-described exemplary embodiments, it is possible to set the appropriate maximum value of the length of the side A of a C fold based on the number of sheets to be bundled and the basis weight.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-155479, filed Sep. 21, 2023, which is hereby incorporated by reference herein in its entirety.

What is claimed is:

1. A non-transitory computer-readable storage medium storing a program for causing a computer to perform a method of controlling an information processing apparatus communicable with a printing apparatus through a network, the method comprising:
acquiring information on a function of setting a folding position of a sheet to be folded in three-part folding processing performed by a sheet processing apparatus included in the printing apparatus; and
performing display control to display, on a display unit, a screen in which the folding position is settable based on the acquired information.

2. The non-transitory computer-readable storage medium according to claim 1, wherein the method further comprising specifying another folding position different from the folding position, based on the folding position.

3. The non-transitory computer-readable storage medium according to claim 1, wherein the folding position of the sheet is indicated by a length from an end of the sheet to a position where the sheet is folded.

4. The non-transitory computer-readable storage medium according to claim 3, wherein a maximum value of the length from the end of the sheet to the position where the sheet is folded, the maximum value of the length being settable in the screen, is varied depending on a type of the sheet.

5. The non-transitory computer-readable storage medium according to claim 3, wherein a maximum value of the length from the end of the sheet to the position where the sheet is folded, the maximum value of the length being settable in the screen, is varied depending on a number of sheets in one bundle output with the sheet.

6. The non-transitory computer-readable storage medium according to claim 1, wherein the screen displays an icon of a sheet folded in the three-part folding processing.

7. The non-transitory computer-readable storage medium according to claim 1, wherein the information is information indicating whether the printing apparatus includes a function of setting the folding position of the sheet to be folded in the three-part folding processing.

8. The non-transitory computer-readable storage medium according to claim 7,
wherein the method further comprises determining whether the printing apparatus has the function of setting the folding position of the sheet to be folded in the three-part folding processing, based on the information, and
wherein, in the display control, in a case where it is determined in the determining that the printing apparatus does not have the function of setting the folding position of the sheet to be folded in the three-part folding processing, the screen in which the folding position is settable is not displayed on the display unit, and in a case where it is determined in the determining that the printing apparatus has the function of setting the folding position of the sheet to be folded in the three-part folding processing, the screen in which the folding position is settable is displayed on the display unit.

9. The non-transitory computer-readable storage medium according to claim 1, wherein the program is a printer driver.

10. A method of controlling an information processing apparatus communicable with a printing apparatus through a network, the method comprising:
acquiring information on a function of setting a folding position of a sheet to be folded in three-part folding processing performed by a sheet processing apparatus included in the printing apparatus; and
performing display control to display, on a display unit, a screen in which the folding position is settable based on the acquired information.

11. An information processing apparatus communicable with a printing apparatus through a network, the information processing apparatus comprising:
an acquisition unit configured to acquire information on a function of setting a folding position of a sheet to be folded in three-part folding processing performed by a sheet processing apparatus included in the printing apparatus; and
a display control unit configured to perform display control to display, on a display unit, a screen in which the folding position is settable based on the information acquired by the acquisition unit.
